(19) United States
(12) Patent Application Publication
(10) Pub. No.: US 2011/0125633 A1
(43) Pub. Date: May 26, 2011

(54) TRANSACTION PROCESSING

(75) Inventors: Janne Aaltonen, Turku (FI); David Wilkinson, New Barnet (GB)

(73) Assignee: CVON INNOVATIONS LTD., London (GB)

(21) Appl. No.: 12/745,098

(22) PCT Filed: Dec. 31, 2008
(86) PCT No.: PCT/EP08/68388

§ 371 Date: Jan. 19, 2011

(30) Foreign Application Priority Data
Dec. 31, 2007 (GB) 0725320.6

(51) Int. Cl. G06Q 20/00

(52) U.S. Cl. 705/39

(57) ABSTRACT

In prior art methods of processing transactions, funds for any given transaction are typically designated for payment from a single account. Further, funds are often pre-paid into accounts associated with a subscription to a telecommunications network, reducing the funds that a user can allocate to the single account. This can cause the amount of funds available from the single account to be below that required to cover one or a series of transactions, leading to the problem that only transactions of a limited size or number can be effected for a given account balance. In embodiments of the present invention, a method of processing a transaction is provided in which, responsive to a request for a transaction, a plurality of accounts associated with a party to the transaction are identified, including at least one account associated with a subscription to a telecommunications network. Funds for the transaction are selected on the basis of account balances of the identified accounts. This enables a greater amount of funds to be available for effecting transactions than in prior art methods.

### FIELD OF THE INVENTION

The present invention relates to a system and method for effecting transactions. In particular, the present invention relates to effecting transactions involving multiple accounts.

### BACKGROUND OF THE INVENTION

Transactions relating to payment for goods and services can be implemented using a payment card such as a credit card or debit card which is associated with an account of the user of the card. These cards allow the transaction to be processed by enabling funds to be transferred from the associated account. It is common for a single user to have more than one such account, and a “transaction” here refers to any process in which funds are transferred, or allocated for transfer, from such an account in exchange for goods or services.

Transactions using a payment card typically involve the payment card being used to provide information relating to the account at a point of sale (POS) terminal. An electronic card reading device in a shop or at a ticketing gate and an internet website are examples of a POS terminal. Where a card reading device is used, it may read a magnetic card or processor chip on the payment card. In some systems the payment device is inserted into a reading device at the POS terminal. Other systems employ a “contact-less” method of reading the card using, for example, Radio Frequency Identification (RFID) technology. Contact-less reading may be implemented using, for example, the EMV Contact-less Communication Protocol Specification v.2.0. Contact-less reading methods may be used particularly in cases where, in accordance with recent developments, the functions of a debit and/or credit card have been incorporated into an electronic device such as a mobile telephone.

Where the POS terminal is an internet website, the user typically provides information such as numbers associated with the card. In all cases an amount of funds required for the transaction is specified.

Having acquired the necessary information, the POS terminal then typically communicates with the provider of an account associated with the card to authorise payment of the transaction. This communication may use a standard such as ANSI x9.20, ANSI x9.24-1 or ANSI x9.24-2, for example. The authorisation typically involves steps such as checking the identity of the user of the payment device by, for example, checking that the card is valid and checking that there are sufficient funds available for the transaction in the account associated with the card. There is typically a limit to the amount of funds available from each account associated with a payment device; transactions that results in the balance of the account being exceeded are not authorised. Another method of paying for goods or services is a pre-payment method in which the user makes an advance payment into an account which is specifically allocated for a specific set of goods and/or services; this is particularly common with mobile telephone subscription accounts. Funds are deducted from the account as the service is used, or goods purchased, and access to the service or goods is typically denied when the balance of the account reaches a predefined limit (typically zero).

### SUMMARY OF THE INVENTION

In accordance with at least one embodiment of the invention, methods, systems and software are provided for supporting or implementing functionality to provide processing of a transaction, as specified in the independent claims. This is achieved by a combination of features recited in each independent claim. Accordingly, dependent claims prescribe further detailed implementations of the present invention.

More particularly, aspects of the invention provide a method of processing a transaction, the method comprising: receiving a request for said transaction, said request comprising data indicative of an amount required to effect the transaction;

identifying a plurality of accounts associated with a party to said transaction, each said account having a balance of funds associated therewith, and at least one said account being associated with a subscription to a telecommunications network; and

selecting funds, on the basis of said account balances, from individual ones of said plurality of accounts to effect the transaction.

Thus, the present invention provides a method in which multiple accounts can be used in a single transaction, at least one of which being a mobile phone account. This allows a greater amount of funds to be used for a single transaction than is possible in prior art systems in which only a single account can be used for any one transaction; in addition it has the particular benefit of enabling a user to complete a transaction using funds from an account that is conventionally restricted to use in offsetting usage of telecommunications network resources.

In some embodiments, the method comprises determining that a balance of a first said account is insufficient to provide all funds required for said transaction, and selecting funds from a second account on the basis of said determination. Thus, where insufficient funds are available in one account, another account can be used to provide further required funds.

In some arrangements of embodiments of the invention, the selecting is performed on the basis of rules associated with said party. This allows funds to be allocated according to user preference; some users may want to specify a particular account which should be prioritised for fund allocation, for example.

The method may comprise storing balance information for at least one of said plurality of accounts, and accessing said balance information, whereby to select said funds.

In some arrangements of embodiments of the invention, a request is sent to a party to the transaction so as to confirm that funds may be selected from a given one of said accounts. It may be desirable to provide the user with the opportunity to decide not to proceed with a transaction in the case that funds are allocated to be transferred from an account from which he or she does not wish funds to be withdrawn; this may be the case if, for example, the account is a mobile telephone operator account, and the user needs to use this service.

Additionally, or alternatively, a requesting party of said transaction may be authorised. This ensures that funds are not caused to be allocated or transferred by parties who are not authorised to do so.

According to a second aspect of the present invention, there is provided a system for processing a transaction, said system comprising an interface for receiving a request for said transaction, the request comprising data indicative of an amount required to effect the transaction, wherein said system is arranged to:

access balance information relating to each of a plurality of accounts associated with a party to said transaction, at least one of said accounts being associated with a subscription to a telecommunications network; and

selectively allocate funds from said accounts to effect said transaction.

The system may be arranged to determine, based on the balance information, whether a balance of a first account is sufficient to provide all funds required for said transaction, and, in the case that the balance of the first account is determined to be insufficient, to distribute allocation of the funds required for said transaction between said first account and least one further account.

In one arrangement of embodiments of the invention, the system comprises a store for holding balance information relating to at least one of said plurality of accounts, and the system is arranged to perform said allocation on the basis of the balance information held in said store. Storing balance information locally allows funds to be allocated without having to obtain such information from all account providers involved in the transaction in real time; this avoids potential delays in processing the transaction due to the time required to obtain the balance information from the account providers.

The system may be arranged to contact an account provider via a network and thereby update the balance information stored in said store. This ensures that the stored balance information accurately reflects the actual current condition of the account balance.

In one arrangement according to embodiments of the invention, the system is arranged to contact the account provider independently of receiving said request for a transaction. This allows the accuracy of the stored balance information to be maintained.

The system may be arranged to contact the account provider at a predetermined frequency. The frequency may be determined according to a profile of said party. Additionally, or alternatively, the frequency may be varied according to a time of day. Additionally, or alternatively, the frequency may be varied according to a load on said network. These features allow the stored balance information to be updated efficiently and conveniently.

According to a further aspect of the present invention, there is provided a recording medium having recorded therein computer-implementable instructions to perform a method according to a first aspect of the present invention. Other aspects of the invention include provision of a computer program product comprising a computer-readable medium having computer readable instructions recorded thereon for processing a transaction, the computer readable instructions being operative, when performed by a computerized device, to cause the computerized device to perform a method according to a first aspect of the present invention. In addition there is provided a database for use with a system for processing a transaction, comprising balance information relating to at least one of a plurality of accounts associated with a party to said transaction, at least one of said plurality of accounts being associated with a subscription to a telecommunications network, wherein:

said database is accessible by said system to provide said balance information to said system; and

said database is arranged to intermittently contact an account provider of said at least one account and thereby update said balance information.

In a further arrangement, embodiments of the invention can be characterised as providing a method of processing a transaction in a data communications network in response to receiving a request for a transaction, the request comprising data indicative of an amount required to effect the transaction. The method additionally involves identifying a plurality of accounts associated with a party to said transaction, where each of the accounts has access to an amount of funds, and at least one said account is associated with a subscription to a telecommunications network. Once the accounts have been identified the method involves selecting funds, on the basis of the amounts of funds, from individual ones of the plurality of accounts to effect the transaction.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 is a block diagram showing an example of a system in which embodiments of the present invention can be implemented;

FIG. 2 is a flow diagram showing an example of a clearing house processing a transaction in accordance with an embodiment of the present invention; and

FIG. 3 is a schematic timing diagram showing an example transaction being performed in accordance with an embodiment of the present invention.

### DETAILED DESCRIPTION OF THE INVENTION

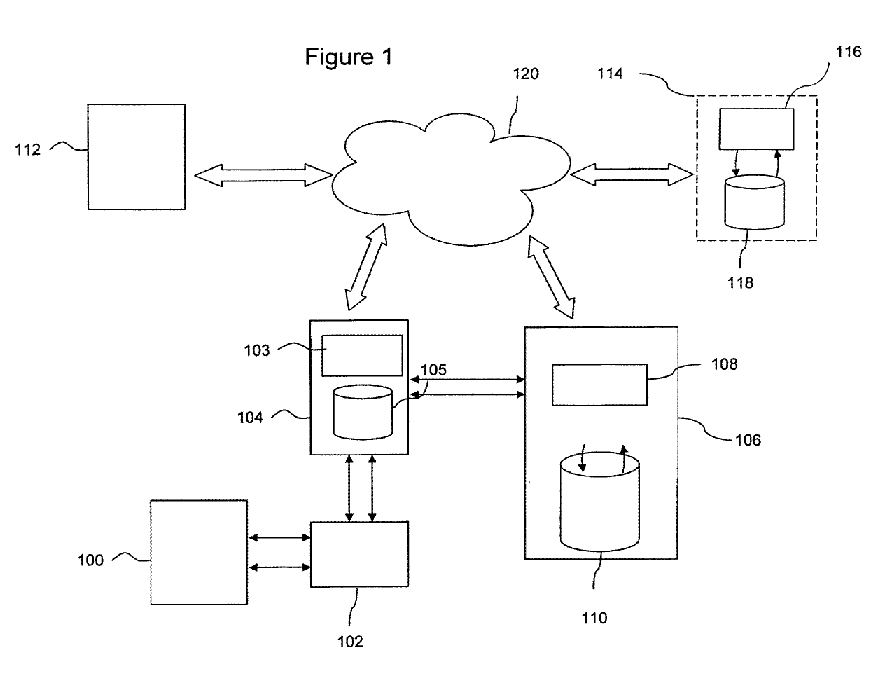

FIG. 1 shows an exemplary system in which embodiments of the present invention can be implemented. The system shown comprises a POS terminal 102 which communicates with a payment device 100, which may be a credit card, debit card, mobile telephone, or any other device capable of providing the POS terminal with information for effecting a transaction. The payment device 100 may be specifically arranged for use with systems in accordance with embodiments of the present invention.

In accordance with an embodiment of the present invention, the POS terminal is arranged to communicate with a clearing house (CH) 104 which comprises a processor 103 and a database 105 containing, inter alia, information relating to users of the service and corresponding account information. The profiles and account information may be provided in advance by users of the service provided by the system.

The CH 104 is arranged to communicate directly with a response unit (RU) 106 which comprises a processor 108 and a cache 110. The cache 110 may comprise a database. The RU 106 may be based on an intelligent voice response (IVR) unit. A purpose of the RU 106 is to store balance information in the cache 110, allowing the CH 104 to quickly access this information without the delays concomitant with directly contacting an account provider. Balance information typically comprises an indication of a balance of funds available from an account. In the case of a credit card, this may be the maximum amount that can be used without exceeding a credit limit; in the case of a debit card, it may be the maximum amount that can be used without the balance of the account falling below zero, or some other defined limit. In some cases the cache 110 may contain balance information relating to all accounts associated with the user; in other cases it may contain balance information relating to only some of the accounts. The RU 106 contacts account providers intermittently in order to update the account information; this updating will be described below.

In this exemplary system, the CH 104 and the RU 106 are each capable of communicating with a bank 112 and a mobile telephone operator 114, via a data communications network 120 which may comprise the internet. The term “bank” is used herein to include credit providing institutions such credit card companies and companies providing loans, as well as institutions for receiving, lending, keeping and/or exchanging funds. The mobile telephone operator can, and for illustrative purposes is assumed to, comprise a control function 116 connected to an account balance database 118. The account balance database 118 stores data relating to users of a service provided by the mobile telephone operator 114, such as a prepaid account balance.

Further, while only one bank 112 and one mobile telephone operator 114 are shown in FIG. 1, it will be appreciated that in other arrangements, the CH 104 and RU 106 may communicate with more than one bank or more than one mobile telephone operator. In some arrangements, the CH 104 and RU 106 may communicate with mobile telephone operators only, or with banks only. In yet further arrangements, the CH 104 and RU 106 may communicate with account providers other than banks and mobile telephone operators. Herein, the term “account provider” is used to refer collectively to banks, mobile telephone operators and any other entity with which a user may have an account. “Account” refers to any service allowing a user to deposit, withdraw, exchange and/or borrow funds, and includes, inter alia, checking accounts, current accounts, credit card accounts and subscriptions to mobile telephone or other services.

In some embodiments, some or all of the components shown in FIG. 1 may be implemented using software components on computing devices. In some embodiments, dedicated hardware components such as Application Specific Integrated Circuits (ASIC) may be used.

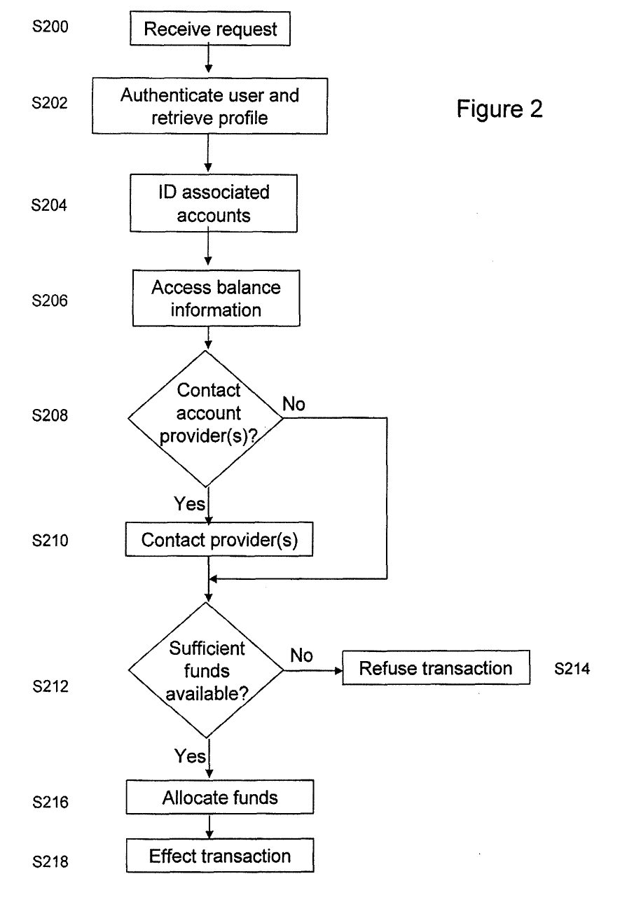

The operation of the CH 104 is now described with reference to FIG. 2. At step S200, the CH receives a request for a transaction from the POS terminal 102. The request typically comprises data indicating an amount of funds required for a transaction, a transaction identifier and identification data allowing a party to the transaction (typically the payer) to be identified; this party will be referred to hereafter as “the user”. The identification information may comprise an identification code similar to a credit card number and/or a personal identification number (PIN) provided by the party.

At step S202 the processor 103 of the CH 104 accesses the database 105 to identify the user; this may include a process to authenticate the user, which may comprise comparing the above mentioned identification information with information stored in the database 105. If the user is authenticated, user profile information is retrieved from the database 105. The user profile information may relate to, inter alia, characteristics of the user, such as age, sex, hobbies and interests and so on, usage of accounts associated with the user, such as frequency of use etc., and/or preferences set by the user, such as an order of preference of accounts for allocating funds for a transaction. Functions of the user profile information will be described below.

At step S204, the processor accesses the database 105 to identify accounts associated with the user; in the present example it identifies one account associated with the bank 112 and one account associated with the mobile telephone operator 114. At step S206 the processor contacts the RU 106 to determine balance information for the accounts identified at step S204; the RU 106 retrieves the required balance information from the cache 110 and communicates it to the CH 104. Step S206 may include determining a length of time since the balance information for an account was updated.

At step S208, the processor 103 determines whether to contact one or more account providers. This may be necessary if, for example, no balance information is available from the RU 106 for a particular account or if the period since the balance data was last updated exceeds a pre-determined threshold, so that the balance information stored at the RU 106 is not a sufficiently accurate reflection of an actual account balance for the purposes of the transaction. This threshold may be fixed for all users, it may vary according to the user, and/or it may vary as a function of the type of account; user profile information may be used to indicate the threshold, which may be based on a frequency of use of the relevant account by the user. Herein, balance information which is a sufficiently accurate reflection of an actual account balance for the purposes of a transaction, is referred to as “current balance information”.

In some arrangements, one or more of the account providers are only contacted in the event that sufficient funds for the transaction are not available from accounts for which current balance information is available from the RU 106. For example, if all funds for the transaction are indicated by the available balance information to be available from an account associated with the bank 112, it may be unnecessary to contact the mobile telephone operator 114 for balance data, even if no current balance information for the mobile telephone operator 114 is available from the RU 106. The order in which account providers are contacted may be based on the user profile information retrieved at step S202.

If the processor determines that a one or more account providers are to be contacted, this is done at step S210, and information relating to a balance obtained. At step S212 the processor 103 determines, based on the balance information obtained from the RU 106 at step S206 and the balance information obtained from the account provider(s) at step S210, whether there are sufficient funds available to effect the transaction. If there are not sufficient funds available, the CH 104 refuses the transaction at step S214. This comprises sending information to the POS terminal 102 indicating that the transaction is refused.

If there are sufficient funds available, the processor 103 allocates funds between the accounts and effects the transaction. Allocation of funds may be based on the user profile information retrieved at step S202. For example, some users may specify that funds are only to be allocated from a mobile telephone operator 114 account in the case that there are insufficient funds available from other accounts. Some users may specify that funds should be allocated from multiple accounts in a predefined ratio, or according to balance information for each account.

At step S218, the CH 104 effects the transaction; this comprises contacting each account provider for which funds have been allocated to request reservation of funds for transfer. This step also includes informing the POS terminal 102 that the transaction is authorised.

The processes described above in relation to FIG. 2 relate primarily to checking the availability of funds, and designating funds for effecting a transaction. Regarding the actual transfer of funds, in many arrangements, funds are not transferred directly from the bank 112 and/or the mobile telephone operator 114 to the POS 102. Instead, the CH 104 provides payment directly to the POS 102 (or, more typically, instructs its bank to provide payment to a bank associated with the POS 102). The CH 104 obtains the funds for the transfer from the user's bank 112 and/or mobile telephone operator 114 as a separate process. In some cases the CH 104 may charge a fee in addition to the cost of the transaction.

Further, it should be noted that the POS 102 is typically coupled with a system of a merchant associated therewith, which, in turn, is coupled with a payment service provider (PSP), which facilitates transactions involving the POS 102. In some arrangements, the CH 104 acts as an intermediary between the merchant and the PSP. In this case, when transferring funds to the merchant's bank account, the CH 104 contacts the PSP and provides it with the transaction identifier received at step S200 along with details of a bank account associated with the CH 104 and details of the merchant; the PSP then manages transfer of funds between the bank account associated with the CH 104 and the merchant bank account.

In some other cases, the CH 104 does not communicate directly with the merchant, but instead receives information, such as the request received at step S200 described above, via the PSP. In this case, the request may comprise an identifier of the CH 104, so that the PSP contacts the CH 104 in order to process the transaction.

As stated above, in preferred arrangements the RU 106 contacts an account provider or account providers intermittently in order to update the balance information stored in the cache 110. The frequency of update may be predefined; in some cases it is the same for all users, or it may vary according to the user. In some arrangements, the frequency may be varied according to the time of day, or according to a load on the communications network via which communication with the account provider is made. In some cases, the account provider may only be contacted if the load on the network is below a certain threshold. The frequency may also be based on the user profile information so that, for example, the frequency of update is greater for users whose account balances frequently vary than for users whose account balances vary less frequently.

The details of the steps described above in relation to FIG. 2 may be varied within the scope of the present invention. In some arrangements, funds are drawn preferentially from a specified account provider or account providers, with other account providers only being contacted in the event that sufficient funds are not available from the specified account provider(s), irrespective of whether current balance information is available from the RU 106 for the specified account provider(s). This preference may be set, for example, by a user, or the system may be arranged with this preference predetermined; for example, the system may automatically draw funds from accounts associated with banks preferentially over accounts associated with mobile telephone operators.

For example, in the arrangement of FIG. 1, funds may be drawn preferentially from an account associated with the bank 112. In this case, at step S206, only balance information associated with this bank account is initially retrieved from the cache 110. If current balance information is not available from the RU 106 for the bank account, the RU 106 initially only contacts the bank 112 at step S210 to determine a current balance of the bank account. In either case, if sufficient funds are available from the bank account, all funds for the transaction are allocated from the bank account. Accessing the RU 106 for balance information for other accounts and/or contacting account providers other than the bank 112 is only done in the event that sufficient funds are not available from the bank account.

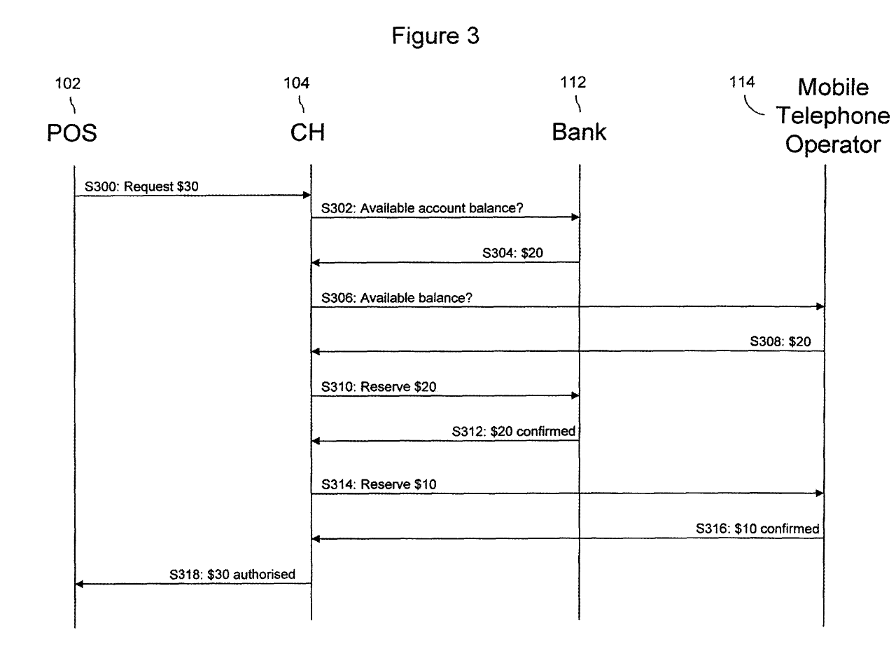

An example session illustrating interactions between the POS terminal 102, the CH 104, the bank 112 and the mobile telephone operator 114 is now described with reference to FIG. 3. At step S300, the POS terminal 102 sends a request for a transaction of amount $30 to the CH 104; as explained above, the request also contains information on the basis of which the CH 104 can identify a party of the transaction.

In this example we assume that the CH 104 does not have access to current balance information from the RU 106. The CH 104 therefore contacts the bank 112 at step S302 to determine the available balance. At step S304, the bank 112 sends a response indicating that the available balance is $20. At step S306, the CH 104 contacts the mobile telephone operator 114 to determine the available balance available from the mobile telephone operator 114. At step S308, the mobile telephone operator 114 sends a response indicating that the available balance is $20.

At this stage, the CH 104 has sufficient information to determine whether there are sufficient funds for the transaction; since the total available funds are greater than the amount required for the transaction, the funds are sufficient. The CH 104 then determines an allocation of the funds. In this example, we assume that the user profile information for the relevant user indicates that the majority of funds required for a transaction are to be taken from the bank account, with the mobile telephone operator 114 account only being used in cases where the balance of the bank account is insufficient. The CH 104 sends a request to the bank 112 to reserve $20 for transfer from the bank account at step S310; at step S312, the bank 112 sends confirmation of this reservation. The CH 104 then sends a request to the mobile telephone operator 114 to reserve $10 for transfer from the mobile telephone operator account at step S314. At step S316, the mobile telephone operator 114 sends confirmation of this reservation. Since all necessary funds have been reserved, the CH 104 sends a confirmation to the POS terminal 102 that the $30 transaction has been authorised at step S318.

The above embodiments are to be understood as illustrative examples of the invention. Further embodiments of the invention are envisaged. For example, in some arrangements the RU 106 is not used, the CH 104 instead obtaining any necessary balance data from the bank 112 and the mobile telephone operator 114 (and other account providers) directly.

Further, in some embodiments, the details of the steps described in relation to FIG. 2 are different. For example, in some embodiments, allocation of funds can be performed on the basis of balance information only rather than on the basis of user profile information.

Whilst in the above embodiments funds are unconditionally allocated from a given account, in other arrangements, the CH 104 may ask for confirmation from a user that funds may be allocated from a given account.

In the arrangements described above, balance information is described as being obtained for each account involved in the transaction. However, in alternative arrangements the actual balance information is not obtained; instead, a query is sent to the account provider requiring a Boolean response Yes/No by way of indicating whether or not sufficient funds for the transaction are available.

In some embodiments, the control function 116 of the mobile telephone operator 114 may be managed by a bank associated with the mobile telephone operator 114. This bank could then manage fund transfers on behalf of the mobile telephone operator 116, for example, providing credit for transfers as described herein as well as providing funds to the mobile telephone operator 114 for services provided.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A method of processing a transaction in a data communications network, the method comprising:
receiving a request for said transaction, said request comprising data indicative of an amount required to effect the transaction;
identifying a plurality of accounts associated with a party to said transaction, each said account having a balance of funds associated therewith, and at least one said account being associated with a subscription to a telecommunications network; and
selecting funds, on the basis of said account balances, from individual ones of said plurality of accounts to effect the transaction.

2. A method according to claim 1, further comprising determining that a balance of a first said account is insufficient to provide all funds required for said transaction, and selecting funds from a second account on the basis of said determination.

3. A method according to claim 2, in which said second account comprises said account associated with a subscription to a telecommunications network.

4. A method according to claim 1, further comprising performing said selecting on the basis of rules associated with said party.

5. A method according to claim 1, further comprising storing balance information for at least one of said plurality of accounts, and accessing said balance information, whereby to select said funds.

6. A method according to claim 1, further comprising sending a request to a party to the transaction to confirm that funds may be selected from a given one of said accounts.

7. A method according to claim 1, further comprising authenticating a requesting party of said transaction.

8. A system for processing a transaction, said system comprising an interface for receiving a request for said transaction, the request comprising data indicative of an amount required to effect the transaction, wherein said system is arranged to:
access balance information relating to each of a plurality of accounts associated with a party to said transaction, at least one of said accounts being associated with a subscription to a telecommunications network; and
selectively allocate funds from said accounts to effectuate said transaction.

9. A system according to claim 8, wherein said system is arranged to determine, based on the balance information, whether a balance of a first account is sufficient to provide all funds required for said transaction, and, in the case that the balance of the first account is determined to be insufficient, to distribute allocation of the funds required for said transaction between said first account and at least one further account.

10. A system according to claim 8, wherein said system comprises a store for storing balance information relating to at least one of said plurality of accounts, and the system is arranged for perform said allocation on the basis of the balance information stored in said store.

11. A system according to claim 10, wherein said system is arranged to contact an account provider via a network and thereby update the balance information stored in said store.

12. A system according to claim 8, wherein said system is arranged to contact the account provider independently of receiving said request for a transaction.

13. A system according to claim 12, wherein said system is arranged to contact said account provider at a predetermined frequency.

14. A system according to claim 13, wherein said frequency is determined according to a profile of said party.

15. A system according to claim 13, wherein said frequency is varied according to a time of day.

16. A system according to claim 13, wherein said frequency is varied according to a load on said network.

17. A non-transitory computer readable storage medium having stored thereon computer readable program code which, when executed by a computer system, causes said computer system perform the method of claim 1.

18. A computer program product, comprising a non-transitory computer readable storage medium having computer-readable instructions stored thereon for processing a transaction, the computer readable instructions being operative, when executed by a computer system, to cause the computer system to perform the method of claim 1.

19. A database for use with a system for processing a transaction, comprising balance information relating to at least one of plurality of accounts associated with a party to said transaction, at least one of said plurality of accounts being associated with a subscription to a telecommunications network, wherein:
said database is accessible by said system to provide said balance information to said system; and
said database is arranged to intermittently contact an account provider of said at least one account and thereby update said balance information.

20. A method of processing a transaction in a data communications network, the method comprising:
receiving a request for a transaction, the request comprising data indicative of an amount required to effect the transaction;
identifying a plurality of accounts associated with a party to said transaction, each said account having access to an amount of funds, and at least one said account being associated with a subscription to a telecommunications network; and
selecting funds, on a basis of the amounts of funds, from individual ones of said plurality of accounts to effect the transaction.
